(19) United States
(12) Patent Application Publication
(10) Pub. No.: US 2004/0215869 A1
(43) Pub. Date: Oct. 28, 2004

(54) Method and system for scaling memory bandwidth in a data network

(76) Inventors: Adisak Mekkittikul, Mountain View, CA (US); Nader Vijeh, Sunnyvale, CA (US); Komal Rathi, Sunnyvale, CA (US)

Correspondence Address: Lantern Communications, Inc., 1246 Reamwood Avenue, Sunnyvale, CA, 94089, US

(21) Appl. No.: 10/846,178

(22) Filed: May 13, 2004

Related U.S. Application Data
(63) Continuation of application No. 10/056,293, filed on Jan. 23, 2002, now abandoned.

(51) Int. Cl. G06F 12/00; G06F 13/00; G06F 15/16

(52) U.S. Cl. 711/100; 709/201; 370/412

(57) ABSTRACT

A method and apparatus for randomly selecting which of a plurality of memory modules data packets are to be written to in a network packet buffer. Memory modules are coupled in parallel to effectively increase the overall memory bandwidth. In order to minimize latency, each time an incoming packet is received by the network switch, a scheduler randomly selects one of the memory modules to which that packet is to be stored upon. And because the data is randomly distributed amongst the different memory modules, read operations will be similarly random across all memory modules. This ensures minimal read latencies when reading data from the memories. Thereby, the delays are minimized.

### FIELD OF THE INVENTION

The present invention relates to a method and apparatus for scaling and increasing memory bandwidth by randomly writing data packets in a randomized manner to parallel memory modules of a network packet buffer.

### BACKGROUND OF THE INVENTION

Communications networks are critical for carrying digital information. In order to meet the virtually insatiable demand imposed by Interment, IP telephony, video teleconferencing, e-commerce, file transfers, e-mail, etc., networks designers are striving to continuously increase network bandwidth. Indeed, fiber optic networks are now routinely handling bandwidths in excess of 10 Gbps (gigabytes per second). The manner by which digital information is conveyed through these networks entails breaking the digital data into a number of small “packets.” These packets of data are routed through the communications network via a number of routers, hubs, and/or switches which direct the flow of these data packets through the network.

In order to properly route the data packets, these network nodes would often temporarily have to “buffer” or store incoming data packets. Typically, the buffered data packets are stored in random access memory (RAM) chips. Random access performance is of particular importance in data networks since the destinations of arriving and departing data packets are extremely random in nature and because packets are often buffered separately according to their destination.

However, the bandwidth of networks is rapidly surpassing the rate by which data can be efficiently accessed from the random access memories. Memory speed is a bottleneck in data networks since memory access rates have not kept up with the increased bandwidth of communications networks. It is anticipated that this problem will worsen as data networking bandwidth increases by many orders of magnitude while memory storage access rates increase by less than one order of magnitude. For example, as shown in FIG. 1, if a switch is operating at 10 Gbps, it needs a memory bandwidth of at least 20 Gbps in order to both read and write packets at line-rate. For efficient memory utilization, it is common practice to write packets in memory as fixed-sized units. Assuming that each unit is of 64 bytes, and the bus width and the block size of the memory is also of 64 bytes, this means that a read/write of a single unit takes one memory operation. At 20 Gbps, an operation every 64*8/20=25.6 ns is required. If the line-rate is 40 Gbps, this necessitates an access time of 6.4 ns.

One approach used to increase data buffering speed has been to simply use the fastest memory technology available. For example, many network nodes use static random access memory chips (SRAMs). Data can be written to and read from SRAMs relatively quickly. By comparison, data entry stored in SRAM can be randomly accessed as fast as 3 nanoseconds (ns) whereas the same entry may take 50-100 ns to access when stored in a more traditional dynamic random access memory (DRAM). Unfortunately, SRAM memory chips are prohibitively expensive because they are more complex to manufacture. Although SRAMs offer a speed increase of several times over the simpler, cheaper dynamic random access memory (DRAM) chips, the SRAMs cost approximately ten times that of DRAMs. Given that switches buffer packets worth at least one round-trip time, the Internet today has a typical RTT of 0.25 s. This means that at 10 Gbps line-rate, the switch needs to provide at least 2.5 Gb of memory. This size is too large for SRAM to be cost-effective. Hence, slower but cheaper DRAM are the preferred solution for packet buffers.

Another method of improving memory access entails widening the memory bus so that more bits can be read from and written to memory per clock cycle. However, this approach is not ideal for use in data networks because the minimum size of a data block to be transferred into memory should be no smaller than the width of the memory bus. Consequently, for a given small data packet size, an increase in the memory bus width only results in a decrease in the efficiency of data memory access. For data packets which are smaller than the block transfer size, memory bandwidth is underutilized and memory bandwidth is effectively limited. In the above example, if the bus width and hence, the minimum block size, is to be widened to 128 bytes, one would need an operation every 51.2 ns. And if the bus width were to be increased further, one would achieve the desired bandwidth. However, the block size can be only as small as the bus Width. In today's Internet, packets can be as small as 44 bytes. It is obvious that increasing the block size will lead to wastage of memory and more importantly, memory bandwidth. Furthermore, simply adding more memory in parallel will not solve the memory bandwidth problem because the desired data often resides within the same memory chip. As such, having additional parallel memories offers no solution.

Therefore, there is a need for a method and system for eliminating the memory bandwidth bottleneck for today's networking applications. It would be preferable for such a method and system to transfer data in and out of memory within a data network which is both fast, economical, efficient, and scaleable. The invention described herein provides for such one such unique, novel method and system.

### SUMMARY OF THE INVENTION

The present invention pertains to a method and apparatus for randomly selecting which of a plurality of memory modules data packets are to be written to in a network packet buffer. Memory modules are coupled in parallel to effectively increase the overall memory bandwidth. Each time an incoming packet is received by the network switch, a scheduler randomly selects one of the memory modules to which that packet is to be stored upon. By randomly selecting memory module, it guarantees that the probability of encountering worst-case latency is minimized and bounded. And because the data is randomly distributed amongst the different memory modules, read operations will be similarly random across all memory modules regardless of the read process. This ensures minimal read latencies when reading data from the memories. Essentially, the read/write delays are quite small and the probability of encountering worst-case latency follows a binomial distribution.

### BRIEF DESCRIPTION OF THE DRAWINGS

The operation of this invention can be best visualized by reference to the following drawings described below.

FIG. 1 shows a prior art main memory system.

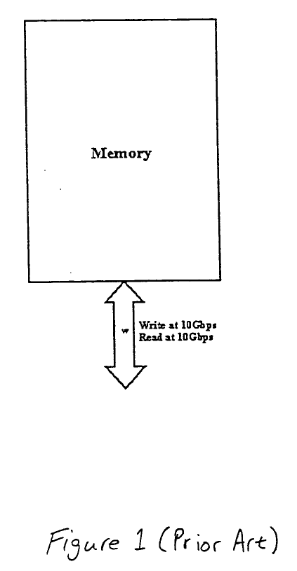

FIG. 2 shows a packet buffer in an exemplary network node.

FIG. 3 shows a number of memory modules arranged in a parallel configuration as may be used for packet buffering according to the currently preferred embodiment of the present invention.

FIG. 4 is a plot of the probability that at least any k of 500 consecutive requests (read or write) will be to a module for four modules.

FIG. 5 is a plot of the probability that at least any k of 500 consecutive requests (read or write) will be to a module for eight modules.

FIG. 6 is a flowchart describing the steps for buffering packets in a network node/switch according to the currently preferred embodiment of the present invention.

### DETAILED DESCRIPTION OF THE PREFERRED EMBODIMENTS

Described in detail below is a method and system for randomly writing data packets in a randomized manner to parallel memory modules of a network packet buffer. In the following description, for purposes of explanation, numerous specific details are set forth in order to provide a thorough understanding of the present invention. It will be obvious, however, to one skilled in the art that the present invention may be practiced without these specific details. In other instances, well-known structures and devices are shown in block diagram form in order to avoid obscuring the present invention.

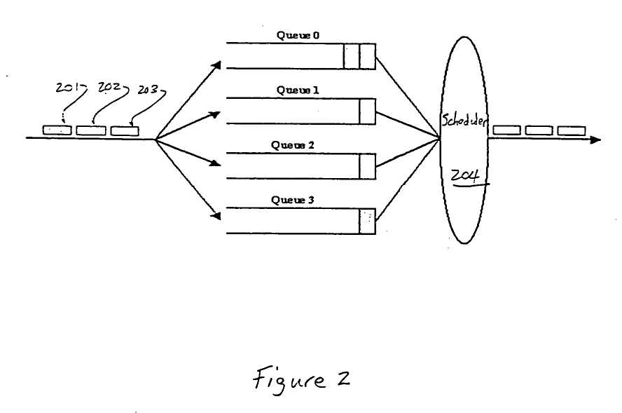

FIG. 2 shows a packet buffer in an exemplary network node. One network node upon which the present invention may be practiced is a metropolitan packet switch supporting a metropolitan packet transport ring as described in the patent application entitled, “Guaranteed Quality of Service In An Asynchronous Metro Packet Transport Ring,” Ser. No. 09/608,747, filed Jul. 6, 2000, and which is incorporated by reference in its entirety herein. Incoming data packets 201-203 are first queued into one or more queues (e.g., Queue 0 through Queue 3). Packets are written into the buffer in the respective queue in the order by which they arrive. The queues are comprised of first-in first-out (FIFO) memory. In other words, within a particular queue, the packets are read out in the same order by which they were previously written into. The sequence by which packets are read from the buffer is determined by the scheduler 204.

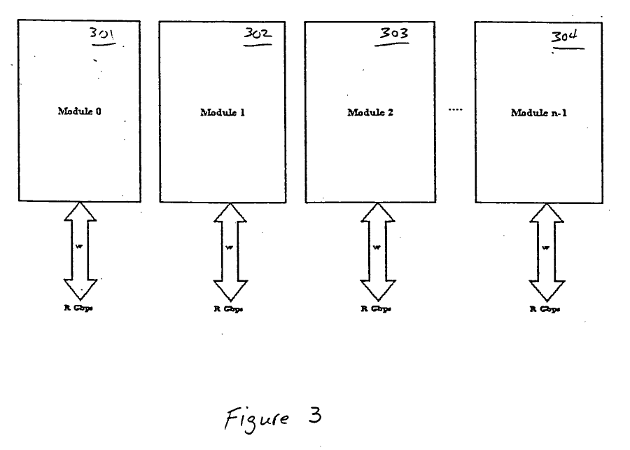

It is a requirement of data networks that a particular packet be delivered within a bounded latency acceptable to that packet. This constraint is met by the present invention by means of randomly selecting memory modules when writing to two or more parallel memory modules. FIG. 3 shows a number of memory modules arranged in a parallel configuration as may be used for packet buffering according to the currently preferred embodiment of the present invention. Any number of memory modules 301-304 can be placed in parallel such that, together, their combined memory bandwidths can meet the desired total packet buffer bandwidth requirement. By this manner, each of the individual memory modules can then be of narrower width and smaller bandwidth. In other words, by coupling a number of memory modules in parallel together, the aggregate of these plurality of individual DRAM memory modules, can sum up to the desired bandwidth. Data can be written to the memory modules in parallel. The memory controller can issue multiple write operations to simultaneously write data to multiple memory modules. Likewise, the memory controller can issue multiple read operations to read data from multiple memory modules at the same time. In the currently preferred embodiment, an individual memory module is comprised of DRAM memory. For example, DRAM memory modules having a 5 Gigabit per second (5 Gps) bandwidth can be used. It should be noted that the present invention applies equally well to other types of memories, such as SRAM, FLASH, mRAM (magnetic RAM), etc. Furthermore, the present invention is applicable where the memory comprises virtual memory as well as disk array memory.

One problem with coupling memory modules in parallel is that severe latency problems may arise if consecutive reads or writes were to be made to the same module. For example, if the desired data packets predominately reside in Module 0, then the read operations are predominately made to Module 0. Meanwhile, the bandwidth of the other modules (Module 1 to Module n−1) is basically wasted. The present invention solves this problem by randomly selecting memory modules. And since write operations to the memory modules can be controlled, all incoming data packets are selectively written into the randomly selected memory modules. By intentionally making the memory module selection statistically random, the probability of encountering worst-case latency is thereby minimized and limited. When an incoming packet is received, it is queued into the queue which corresponds to a randomly selected memory module. And because the writes are thusly controlled, memory module conflicts are minimized while writing packets. In one embodiment, a pseudo-random selection of locations for writing data is utilized.

The read operations, on the other hand, may not be random. This is due to the fact that the desired packets to be read from the memory modules are determined by the scheduler 204. But since the data packets were all written independent of the scheduling (read) process, the memory module containing any packet that the scheduler chooses, will be at random with respect to the one from the previously chosen packet. As such, memory module conflicts encountered during read operations will, likewise, be minimized and limited. The sequence of memory modules the scheduler reads is completely random with an independent identical distribution property.

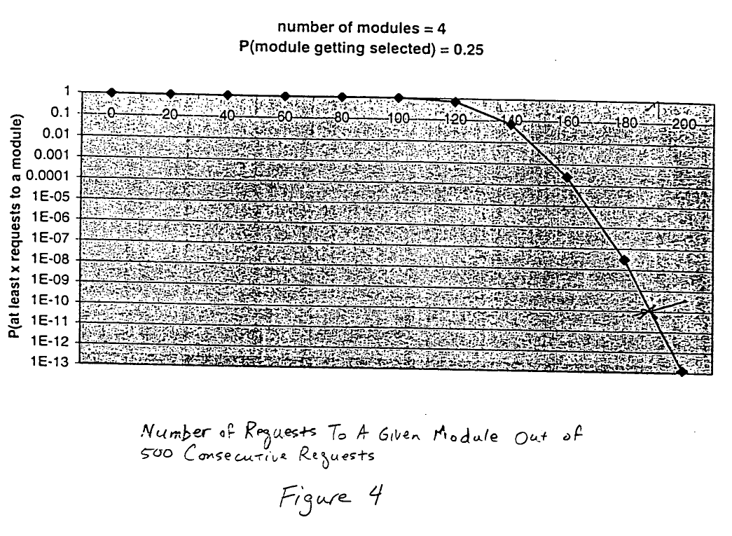

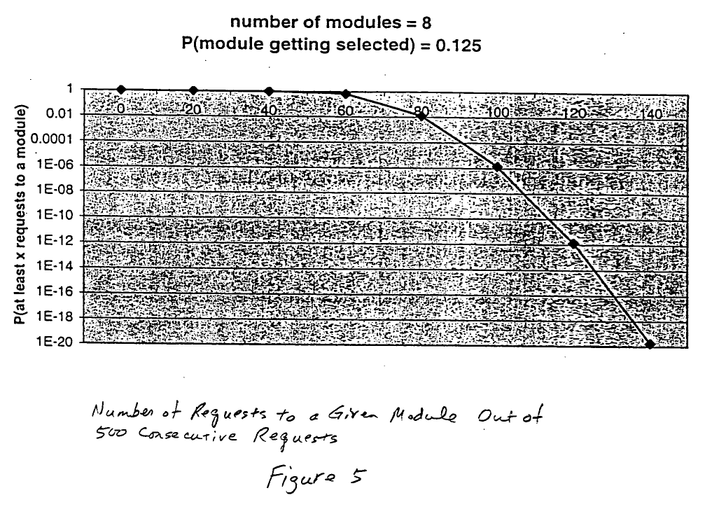

Assume that there are “n” memory modules, each of width “w” and capable of doing data transfer at “R” Gbps. In fact, the probability that out of “n” consecutive requests, any “n” requests are to the same memory module has a binomial distribution. With n=500 consecutive requests, the distribution is plotted in FIGS. 4 and 5, for n=4 modules and n=8 modules respectively. In FIG. 4, the probability of greater than 160 requests, out of 500 requests are to the same module is small. True, it can be said that the probability that a request made to a module has to wait for greater than service time of 160 requests is highly unlikely and therefore becomes negligible. Hence the probability that a request experiences a high delay is practically bounded. Similarly, in FIG. 5, the probability of greater than 100 requests, out of 500 consecutive requests, are to the same module is small.

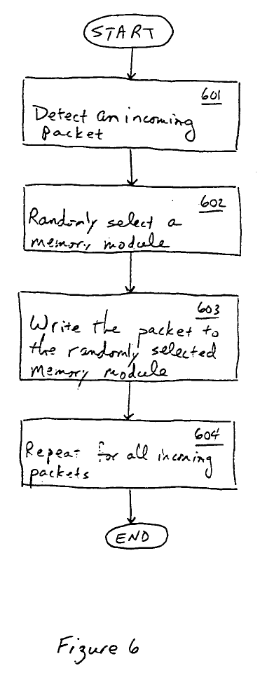

FIG. 6 is a flowchart describing the steps for buffering packets in a network node/switch according to the currently preferred embodiment of the present invention. Initially, an incoming packet is detected, step 601. One of the memory modules coupled in parallel is selected at random in step 602. The incoming packet is directed to the queue corresponding to the randomly selected memory module. Eventually, the contents of the incoming packet is written into that randomly selected memory module, step 603. Information concerning which of the memory modules contain which data is maintained by the memory controller so that the data can be read back from the memory modules. And since the data was written in a random manner to the memory modules, the module selected for a read operation will also be in a random fashion. This process of steps 601-603 is repeated for all incoming packets, step 604.

Thus, a method and apparatus for randomly writing data packets in a randomized manner to parallel memory modules of a network packet buffer is disclosed. It should be noted that the present invention is not limited to networking applications. The present invention is applicable to any type of situation where increased memory throughput is of importance. In other words, the present invention can be used in any application required faster memory bandwidth (e.g., 3D graphics rendering, video/image processing, digital signal processing, as well as any computationally intensive processing, etc.). The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. In a computer network having a plurality of network nodes, a method for buffering packets comprising:
receiving a packet incoming from said network;
randomly selecting a particular memory module from a plurality of memory modules coupled in parallel;
storing said packet in said particular memory module.

2. The method of claim 1 further comprising the step of queuing said packet in a queue corresponding to the particular memory module.

3. The method of claim 1 further comprising the step of reading data from said plurality of memory modules in a random order by which said data was written to said plurality of memory modules.

4. The method of claim 1 wherein said memory modules comprise DRAM memory.

5. The method of claim 1, wherein said DRAM memory comprise 5 Gps bandwidth.

6. The method of claim 1, wherein said plurality of memory modules comprise SRAM memory.

7. The method of claim 1, wherein delays corresponding to writing data into said plurality of memory modules can be described by a binomial distribution.

8. An apparatus, comprising:
a plurality of memories coupled in parallel;
a scheduler coupled to said plurality of memories, wherein the scheduler randomly selects which of said memories data is to be written.

9. The apparatus of claim 8 further comprising a plurality of queues coupled to the plurality of memories, wherein said scheduler directs a data packet to one of said plurality of queues randomly.

10. The apparatus of claim 8, wherein delay associated with writing data to the plurality of memories can be described by a binomial distribution.

11. The apparatus of claim 8, wherein said plurality of memories comprise DRAM memory modules.

12. The apparatus of Claim element of claim 8, wherein said plurality of memories comprise SRAM memory modules.

13. A system, comprising:
a plurality of memories;
a memory controller coupled to said plurality of memories, wherein data is written to random locations of said plurality of memories.

14. The system of claim 13, wherein the plurality of memories are coupled in parallel and total memory bandwidth equals a sum of memory bandwidths of said plurality of memories.

15. The system of claim 13, wherein packets from a network are queued and stored in randomly selected memory modules of said plurality of memories.

16. The system of claim 15, wherein said plurality of memory modules comprise DRAM memories.

17. The system of claim 13, wherein worst-case memory access latency is minimized.

18. The system of claim 13, wherein worst-case memory access latency is controlled by a binomial distribution.

19. The system of claim 13, wherein a probability that a memory is selected to read/write a packet into is randomly uniformly distributed.

20. The system of claim 13, wherein a probability that at least x of n requests will be written to a module comprise a binomial distribution function.
